(19) United States
(12) Patent Application Publication
(10) Pub. No.: US 2025/0390109 A1
(43) Pub. Date: Dec. 25, 2025

(54) MOBILE DEVICE AND METHOD FOR CONTROLLING MOBILE DEVICE

(71) Applicant: Sony Group Corporation, Tokyo (JP)

(72) Inventor: Junji KATO, Tokyo (JP)

(73) Assignee: Sony Group Corporation, Tokyo (JP)

(21) Appl. No.: 18/881,380

(22) PCT Filed: May 17, 2023
(86) PCT No.: PCT/JP2023/018412

§ 371 Date: Jan. 6, 2025

(30) Foreign Application Priority Data
Jul. 13, 2022 (JP) 2022-112248

(51) Int. Cl. G05D 1/65; G05D 1/226; G05D 1/227; G05D 109/10; G05D 111/30; H04W 4/44; H04W 28/24

(52) U.S. Cl. CPC G05D 1/65; G05D 1/226; G05D 1/2274; H04W 4/44; H04W 28/24; G05D 2109/10; G05D 2111/32

(57) ABSTRACT

The safety of a mobile device that is operated remotely is improved. The mobile device includes a communication unit, a communication quality prediction unit, an operation mode control unit, and a speed control unit. The communication unit transmits and receives data to and from a controller through a predetermined communication path. The communication quality prediction unit predicts a communication quality of the communication path and obtains a predicted value. The operation mode control unit selects, on the basis of the predicted value, one of a plurality of operation modes, each defining an operation method for a remote operator of the controller. The speed control unit controls a travel speed on the basis of the predicted value when a specific operation mode is selected from among the plurality of operation modes.

### TECHNICAL FIELD

The present technique relates to a mobile device. In particular, the present technique relates to a mobile device which communicates with an external controller, and a method of controlling the mobile device.

### BACKGROUND ART

In recent years, the development and research of automated driving systems for mobile devices such as automobiles have been progressing, with the aim of preventing accidents, reducing the burden on drivers, and the like. In such an automated driving system, teleoperation technology, in which an operator controls a mobile device remotely, may be used to handle unforeseen circumstances. For example, a system has been proposed that changes a level of independence during remote operation according to the communication quality (see PTL 1, for example).

### Citation List

### Patent Literature

PTL1

JP 2011-150516A

### SUMMARY

### Technical Problem

In the conventional technique described above, remote operation of the mobile device is facilitated by changing the level of independence according to the communication quality. However, in the system described above, as the travel speed of the mobile device increases, it becomes more likely that the remote operator will not be able to perform operations in time, and that the operator will overlook obstacles, humans, and the like. It is therefore desirable to further improve the safety.

Having been conceived in light of such circumstances, an object of the present technique is to improve safety in a mobile device operated remotely.

### Solution to Problem

The present technique has been achieved to solve the foregoing problem, and a first aspect thereof is a mobile device, and a method of controlling the same, the mobile device including: a communication unit that transmits and receives data to and from a controller through a predetermined communication path; a communication quality prediction unit that predicts a communication quality of the communication path and obtains a predicted value; an operation mode control unit that, on the basis of the predicted value, selects one of a plurality of operation modes, each defining an operation method for a remote operator of the controller; and a speed control unit that controls a travel speed on the basis of the predicted value when a specific operation mode is selected from among the plurality of operation modes. This provides an effect in that safety is improved.

In the first aspect, when the predicted value does not meet a required quality that is a communication quality required for a current speed, the speed control unit may control the travel speed to a speed that is not lower than a predetermined minimum travel speed and that meets the required quality. This provides an effect in that the speed is controlled to an appropriate speed.

In the first aspect, the mobile device may further include a required quality table in which a required quality is associated with each of speeds, and the speed control unit may obtain the required quality from the required quality table. This provides an effect in that calculations for obtaining an appropriate speed need not be performed.

In the first aspect, a required quality that is a required communication quality may be associated with each of the plurality of operation modes, and the operation mode control unit may select, from the plurality of operation modes, an operation mode in which the predicted value meets the required quality. This provides an effect in that an appropriate operation mode is selected.

In the first aspect, the communication path may include an uplink that is a path from the controller to the mobile device, and a downlink that is a path from the mobile device to the controller. This provides an effect in that the communication qualities of the uplink and the downlink are predicted.

In the first aspect, the communication quality may include at least one of an average throughput, an average latency, and jitter. This provides an effect in that the average throughput and the like are predicted.

### BRIEF DESCRIPTION OF DRAWINGS

FIG. 1 is a diagram illustrating an example of the configuration of a wireless communication system in a first embodiment of the present technique.

FIG. 2 is a block diagram illustrating an example of the configuration of a mobile device in the first embodiment of the present technique.

FIG. 3 is a block diagram illustrating an example of the configuration of an automated/remote driving control unit in the first embodiment of the present technique.

FIG. 4 is a block diagram illustrating an example of the configuration of a remote operation processing unit in the first embodiment of the present technique.

FIG. 5 is a block diagram illustrating an example of the configuration of an operation mode communication quality requirement determination unit in the first embodiment of the present technique.

FIG. 6 is a block diagram illustrating an example of the configuration of a controller in the first embodiment of the present technique.

FIG. 7 is a block diagram illustrating an example of the configuration of a remote operation control unit in the first embodiment of the present technique.

FIG. 8 is a diagram illustrating an example of a required quality for each of speeds of the mobile device in the first embodiment of the present technique.

FIG. 9 is a flowchart illustrating an example of operations by the mobile device in the first embodiment of the present technique.

FIG. 10 is a block diagram illustrating an example of the configuration of a remote operation processing unit in a second embodiment of the present technique.

FIG. 11 is a block diagram illustrating an example of the configuration of an operation mode communication quality requirement determination unit in the second embodiment of the present technique.

FIG. 12 is a block diagram illustrating an example of the configuration of a remote operation control unit in the second embodiment of the present technique.

FIG. 13 is a diagram illustrating an example of a required quality corresponding to an operation mode B in the second embodiment of the present technique.

FIG. 14 is a flowchart illustrating an example of operations by a mobile device in the second embodiment of the present technique.

FIG. 15 is a block diagram illustrating a schematic example of the configuration of a vehicle control system.

FIG. 16 is an explanatory diagram illustrating an example of installation positions of image capturing units.

### DESCRIPTION OF EMBODIMENTS

Modes for carrying out the present technique (called “embodiments” hereinafter) will be described hereinafter. The descriptions will be given in the following order.
1. First Embodiment (Example of Controlling Speed on Basis of Communication Quality)
2. Second Embodiment (Example of Controlling Speed and Operation Mode on Basis of Communication Quality)
3. Example of Application in Vehicle Control System

### 1. First Embodiment

### Example of Configuration of Wireless Communication System

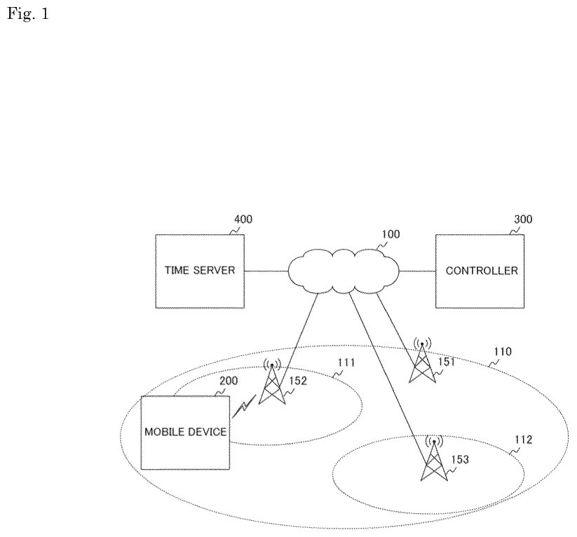

FIG. 1 is a diagram illustrating an example of the configuration of a wireless communication system in a first embodiment of the present technique. This wireless communication system includes a controller 300, a time server 400, a mobile device 200, and a plurality of base stations such as base stations 151 to 153. The base station 151 is provided in a macro cell 110, for example. The base stations 152 and 153 are provided in small cells 111 and 112 within the macro cell 110.

The mobile device 200 is a moving body that can be ridden or the like and operated by an operator in the vicinity thereof, and is assumed to be an automobile, for example. Note that a mobile device other than an automobile, such as a ship, an aircraft, a drone, a robot, or the like, can also be used as the mobile device 200.

The controller 300 is a device for a separate, remote operator to remotely operate the mobile device 200 on behalf of the operator in the vicinity of the mobile device 200. This controller 300 exchanges various types of information with the mobile device 200 through a communication network 100 and the base stations. A core network, the Internet, and the like are used as the communication network 100.

In the following, the operator in the vicinity of the mobile device 200 will be called a “local operator”, and the operator remotely operating the mobile device 200 will be called a “remote operator”. When the mobile device 200 is a device that can be ridden (an automobile or the like), a riding operator (the driver of the automobile or the like) corresponds to the local operator. When the mobile device 200 is a device that cannot be ridden (a drone or the like), an operator operating the mobile device 200 in the vicinity thereof while watching the mobile device 200 corresponds to the local operator.

The base station 151 in the macro cell 110 performs wireless communication using an Ultra High Frequency (UHF) band such as Long Term Evolution (LTE), a low Super High Frequency (SHF) band (Sub6) used in 5G New Radio (NR), or the like. The base station 152 and the like in the small cells perform wireless communication using a high SHF band, an Extremely High Frequency (EHF) band (millimeter waves), or the like used in 5G NR or the like.

The time server 400 obtains the current time in synchronization with a Global Positioning System (GPS) satellite and supplies the current time to the controller 300 over the communication network 100.

### Example of Configuration of Mobile Device

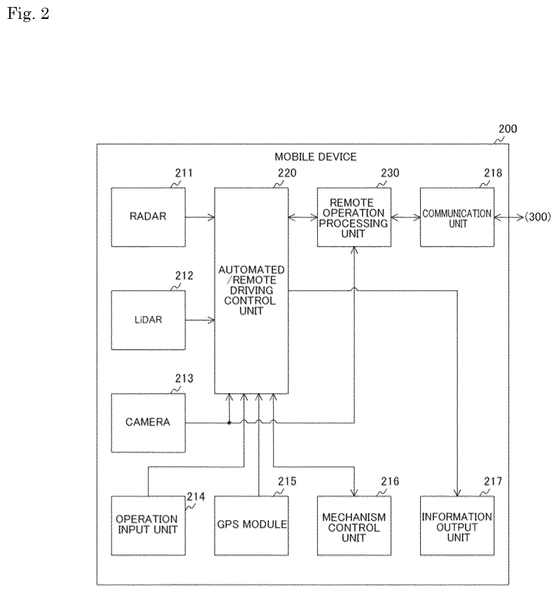

FIG. 2 is a block diagram illustrating an example of the configuration of the mobile device 200 in the first embodiment of the present technique. The mobile device 200 includes a radar 211, Light Detection and DAnging (LiDAR) 212, a camera 213, an operation input unit 214, and a GPS module 215. The mobile device 200 also includes a mechanism control unit 216, an information output unit 217, a communication unit 218, an automated/remote driving control unit 220, and a remote operation processing unit 230.

The radar 211 measures the distance to surrounding objects using millimeter waves. The radar 211 includes a transmitting antenna (not shown) and a receiving antenna (not shown), and measures the distance to an object on the basis of a time difference between when radio waves are transmitted from the transmitting antenna toward the object to when the radio waves are reflected and return to the receiving antenna. The radar 211 then supplies measurement data to the automated/remote driving control unit 220. In order to recognize the state in the periphery of the mobile device 200, a plurality of the radars 211 may be mounted according to the shape thereof. For example, a radar 211 may be mounted at a total of six locations on the mobile device 200, namely the front and the rear, as well as the right-front, the left-front, the right-rear, and the left-rear.

The LiDAR 212 emits a laser beam, such as infrared light, uses a light receiver to receive the light that strikes an object in front or in the vicinity and returns, and then measures the distance to the object on the basis of a time difference arising at that time. The LiDAR 212 supplies measurement data to the automated/remote driving control unit 220. In order to recognize the state in the surroundings of the mobile device 200, a plurality of the LiDARs 212 may be mounted according to the shape thereof.

The camera 213 captures images of the state in the periphery of the mobile device 200, performs image recognition, and detects surrounding objects, pedestrians, traffic signals and signs, white lines on roads, and the like. The camera 213 supplies captured image shooting data, recognition results, and the like to the automated/remote driving control unit 220 and the remote operation processing unit 230.

The operation input unit 214 generates operation data in accordance with operations made by the local operator through an input device. A steering wheel, an accelerator, a brake pedal, and the like can be given as specific examples of input devices. The operation input unit 214 supplies the operation data to the automated/remote driving control unit 220.

The GPS module 215 receives a GPS signal from a GPS satellite and obtains the current position (latitude, longitude, and the like), the current time, and the like of the mobile device 200. The GPS module 215 supplies the obtained data to the automated/remote driving control unit 220.

The mechanism control unit 216 controls a motor, brakes, and a steering device of the mobile device 200 in accordance with the acceleration/deceleration instructions, steering instructions, and the like from the automated/remote driving control unit 220. If acceleration/deceleration is instructed, the mechanism control unit 216 controls a motor that rotates the wheel, the brakes, and the like. If steering is instructed, the mechanism control unit 216 controls the steering device to change the direction of the wheels.

The mechanism control unit 216 also measures the number of rotations of the wheels, and measures the travel speed and the travel distance of the mobile device 200. The mechanism control unit 216 supplies measurement data to the automated/remote driving control unit 220. If the mobile device 200 is an aircraft or a drone, a propeller is controlled by the motor instead of the wheels.

The information output unit 217 outputs data from the automated/remote driving control unit 220 as video, audio, or the like. For example, a status of the mobile device 200 (the speed, travel direction, remaining battery power, and the like), various notification messages (notifications of anomalies in the mobile device 200, notifications from the automated driving system, and the like), and the like are presented to the local operator as video, audio, or the like.

The communication unit 218 communicates with the controller 300 through the macro cell 110, the communication network 100, and the like.

The automated/remote driving control unit 220 generates data for the mechanism control unit 216 and the information output unit 217 on the basis of the data from the radar 211, the LiDAR 212, the camera 213, the operation input unit 214, the GPS module 215, and the remote operation processing unit 230.

The remote operation processing unit 230 exchanges control commands, video, statuses, and the like with the controller 300 through the communication unit 218.

### Example of Configuration of Automated/Remote Driving Control Unit

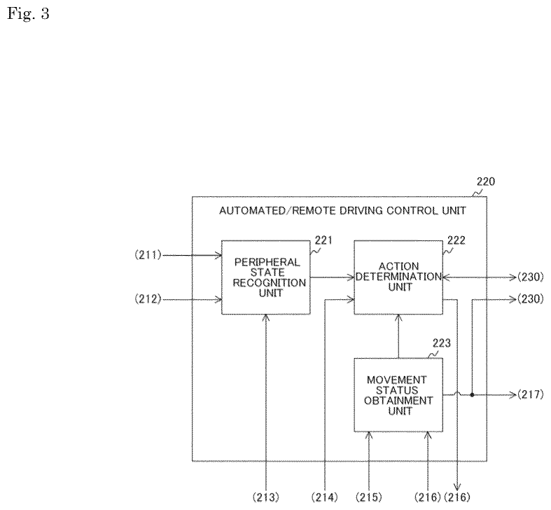

FIG. 3 is a block diagram illustrating an example of the configuration of the automated/remote driving control unit 220 in the first embodiment of the present technique. The automated/remote driving control unit 220 includes a peripheral state recognition unit 221, an action determination unit 222, and a movement status obtainment unit 223.

The peripheral state recognition unit 221 recognizes the state in the periphery using the radar 211, the LiDAR 212, and the camera 213. For example, the peripheral state recognition unit 221 detects white lines on the road surface, traffic signs, other vehicles, people, and other obstacles from the captured image data from the camera 213. The peripheral state recognition unit 221 also detects distances to vehicles, obstacles, and the like, positional relationships therewith, relative speeds thereof, and the like from the measurement data from the radar 211 and the LiDAR 212. The peripheral state recognition unit 221 supplies results of the recognition to the action determination unit 222.

Although the peripheral state recognition unit 221 uses the combination of the radar 211, the LiDAR 212, and the camera 213 (an image sensor), other sensors such as an ultrasonic sensor may be used, and the combination of the sensors may be different.

The movement status obtainment unit 223 obtains a movement status (travel direction, current speed, and the like) of the mobile device 200 on the basis of data from the GPS module 215 and the mechanism control unit 216. The movement status obtainment unit 223 supplies the obtained movement status to the action determination unit 222. The movement status obtainment unit 223 may use other information, such as inertia data from an Inertial Measurement Unit (IMU) sensor, when obtaining the movement status.

The movement status obtainment unit 223 also obtains a minimum travel speed defined by law, corresponding to the road being traveled upon, from the current position measured by the GPS module 215. According to the Road Traffic Act, on expressways and limited highways, travel at a speed lower than a stipulated minimum speed is prohibited except in unavoidable cases such as traffic jams. For example, the movement status obtainment unit 223 stores a minimum travel speed table associating the minimum travel speed defined by law with each road, and obtains the minimum travel speed corresponding to the current position by referring to the table. Alternatively, the movement status obtainment unit 223 obtains the minimum travel speed corresponding to the current position by accessing a database associating the minimum travel speed defined by law with each road over the Internet. The movement status obtainment unit 223 supplies the obtained minimum travel speed to the remote operation processing unit 230 along with the movement status.

The action determination unit 222 controls the mechanism control unit 216 on the basis of the conditions in the periphery, the movement status, operation information, control commands, and the like, and instructs acceleration/deceleration, steering, and the like of the mobile device 200.

Here, one of a plurality of modes, including three modes, namely a remote driving mode, a non-remote manual driving mode, and a non-remote automated driving mode, is set as a driving mode of the mobile device 200.

The remote driving mode is a mode in which the remote operator is the main entity that implements driving tasks of the mobile device 200. However, under specific conditions, the system of the mobile device 200 may control the mobile device 200 instead of the remote operator. When the mobile device 200 performs driving tasks itself, a driving assistance function (automatic braking or the like) or an automated driving function under specific conditions (automated driving on an expressway or the like) is used, for example.

The non-remote manual driving mode is a mode in which the local operator (the driver of the automobile or the like) is the main entity that implements driving tasks. However, under specific conditions, the system of the mobile device 200 may control the mobile device 200 instead of the local operator.

The non-remote automated driving mode is a mode in which the system of the mobile device 200 is the main entity that implements driving tasks. However, the system may request the local operator (the driver or the like) to perform operations under specific conditions.

In the remote driving mode, the action determination unit 222 determines control amounts for acceleration/deceleration, steering, and the like of the mobile device 200 on the basis of control commands from the remote operation processing unit 230 and the movement status from the movement status obtainment unit 223, and makes instructions to the mechanism control unit 216. Note that the action determination unit 222 may determine final control amounts having taken into account judgments made by the driving assistance function, the automated driving function under specific conditions, and the like. Additionally, if the local operator (the driver or the like) has input an operation, the action determination unit 222 may determine the final control amount having taken into account that operation data.

In the non-remote manual driving mode, the action determination unit 222 determines control amounts for acceleration/deceleration, steering, and the like of the mobile device 200 on the basis of the operation data from the operation input unit 214 and the movement status from the movement status obtainment unit 223, and makes instructions to the mechanism control unit 216. Note that the action determination unit 222 may determine final control amounts having taken into account recognition results from the peripheral state recognition unit 221, judgments made by the driving assistance function, the automated driving function under specific conditions, and the like.

In the non-remote automated driving mode, the action determination unit 222 determines control amounts for acceleration/deceleration, steering, and the like of the mobile device 200 on the basis of route plan information set in advance, the operation data, and the movement status, and makes instructions to the mechanism control unit 216. Note that if the action determination unit 222 determines that the judgment of the local operator is required, the local operator may be notified using a means such as causing the information output unit 217 to display a notification message. When the local operator (the driver or the like) then inputs an operation, the action determination unit 222 may determine the final control amount having taken into account that operation data.

Each of the above-described driving modes is set by the action determination unit 222 in accordance with an operation by the local operator, for example. Note that the controller 300 can also set each driving mode.

### Example of Configuration of Remote Operation Processing Unit

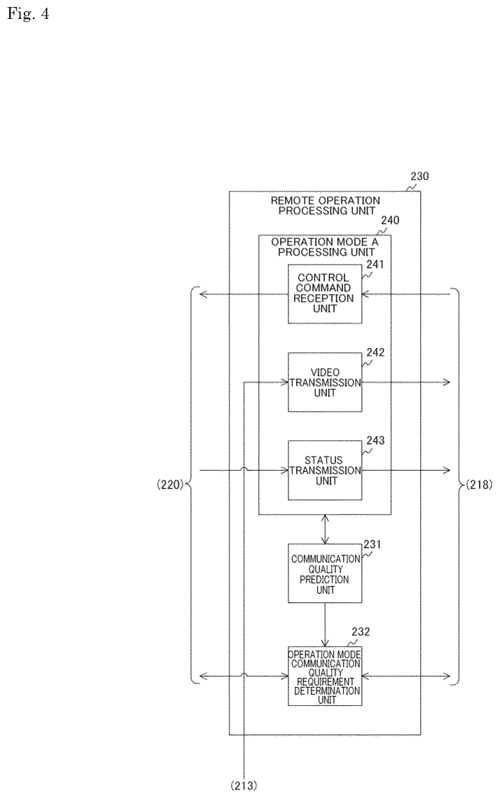

FIG. 4 is a block diagram illustrating an example of the configuration of the remote operation processing unit 230 in the first embodiment of the present technique. The remote operation processing unit 230 includes an operation mode A processing unit 240, a communication quality prediction unit 231, and an operation mode communication quality requirement determination unit 232.

Here, if the remote driving mode has been set in the mobile device 200, the operation mode is set on the controller 300 side. The operation mode defines an operation method implemented by a remote operator, and a plurality of operation modes having different operation methods may be provided. One of the operation modes is set by the remote operator, the controller 300, or the like. The first embodiment assumes that only an operation mode A is set as the operation mode.

The operation mode A is an operation mode in which, using the controller 300, the remote operator performs operations similar to driving operations performed by the local operator (driver) in the driver's seat of the mobile device 200 (e.g., an automobile) using the steering wheel, the accelerator, and the brake pedal.

In the operation mode A, the controller 300 presents received video, the status (speed, travel direction, remaining battery power, and the like), and the like to the remote operator. The remote operator operates the input devices such as the steering wheel, the accelerator, the brake pedal, or the like on the controller 300 side while viewing the presented video, the movement status, and the like. The controller 300 then generates control commands for controlling the mobile device 200 in accordance with the operations by the remote operator, and sends the control commands to the mobile device 200.

The operation mode A processing unit 240 transmits and receives information necessary in the operation mode A, and includes a control command reception unit 241, a video transmission unit 242, and a status transmission unit 243.

The control command reception unit 241 receives the control commands from the controller 300 and supplies the control commands to the automated/remote driving control unit 220. The automated/remote driving control unit 220 controls the movement of the mobile device 200 on the basis of the control commands received from the controller 300, as described above.

The video transmission unit 242 receives the video data from the camera 213, encodes the video data, and transmits the video data to the controller 300 through the communication unit 218 in accordance with a real-time data communication protocol such as Real-time Transport Protocol (RTP). The video transmission unit 242 also receives a reception quality status (latency, packet loss rate, and the like) of the video data from the controller 300 using a flow control protocol such as RTP Control Protocol (RTCP), and controls the transmission rate of the video data in accordance with the reception quality status. For example, the video transmission unit 242 raises the transmission rate when the latency, the packet loss rate, and the like have not worsened, and lowers the transmission rate when the latency, the packet loss rate, and the like have worsened.

The status transmission unit 243 receives the status of the mobile device 200 (the speed, travel direction, remaining battery power, and the like) from the automated/remote driving control unit 220, and transmits the status to the controller 300 through the communication unit 218.

The communication quality prediction unit 231 predicts the communication quality of a communication path from the controller 300 to the mobile device 200. The communication path in this direction will be referred to as a “downlink” hereinafter. The video data of the periphery of the mobile device 200, the status (the speed, travel direction, remaining battery power, and the like), and the like are transmitted over the downlink. At least one standard deviation among average throughput, average latency, and jitter within a set period of time is measured and calculated as the communication quality, for example.

When obtaining the average throughput, the communication quality prediction unit 231 queries and obtains the amount of data transmitted to the controller 300 within a set period of time (e.g., five seconds), and obtains the communication volume per second as the average throughput.

Before measuring the average latency, the mobile device 200 obtains a time synchronized with the GPS satellite through the GPS module 215 in advance, and synchronizes the system clock of the mobile device 200. The controller 300 also accesses the time server 400 over the communication network 100, synchronizes the time through Precision Time Protocol (PTP), and synchronizes the system clock of the controller 300 with the time of the GPS satellite.

Then, to measure the average latency, the controller 300 transmits a delay measurement packet to the mobile device 200. To avoid being affected by the outbound communication quality, for example, a User Datagram Protocol (UDP) packet with a timestamp from immediately prior to the transmission is transmitted as the delay measurement packet. Here, the timestamp indicates the transmission time based on the system clock synchronized between the mobile device 200 and the controller 300.

The communication quality prediction unit 231 on the mobile device 200 side reads out the time from immediately after receiving the packet, and measures the time taken to transmit the packet (the latency). In this method, the communication quality prediction unit 231 periodically (e.g., every 200 milliseconds) measures the latency for a set period of time (e.g., for five seconds), calculates the average value, and takes the result as the average latency.

Although an example of using a delay measurement packet between the controller 300 and the mobile device 200 has been described, the latency can also be measured using a remote operation packet. Additionally, the communication quality prediction unit 231 may measure the latency using the time at which the mobile device has received a Receiver Report, on the basis of a difference between a time at which an RTCP Sender Report was transmitted and a last SR (LSR) stored in the Receiver Report corresponding thereto.

Additionally, the communication quality prediction unit 231 calculates an instantaneous jitter on the basis of a difference between the transmission interval of the delay measurement packet and an interval at which that packet is received by the controller 300. A standard deviation of the instantaneous jitter for a set period of time (e.g., five seconds) is measured, for example.

The communication quality prediction unit 231 notifies the operation mode communication quality requirement determination unit 232 of the average throughput, the average latency, and the jitter value obtained through the method described above as a predicted value of the communication quality. Although the communication quality prediction unit 231 measures at least one of the average throughput, the average latency, and the jitter, other parameters can also be measured as the communication quality.

The operation mode communication quality requirement determination unit 232 determines whether the predicted value of the communication quality meets the communication quality required in the current operation mode. The operation mode communication quality requirement determination unit 232 holds, in advance, information associating operation modes with the communication qualities required by those operation modes. The required communication quality will be referred to as the “required quality” hereinafter. In the operation mode A, it is assumed that the required quality increases with the speed of the mobile device 200.

The operation mode communication quality requirement determination unit 232 receives, from the communication quality prediction unit 231, a measured value of the communication quality (e.g., the average throughput) on the downlink. Taking the communication path from the controller 300 to the mobile device 200 as an “uplink,” the operation mode communication quality requirement determination unit 232 receives, from the controller 300, a measured value of the communication quality on the uplink. The control commands are transmitted over this uplink.

In the operation mode A, the operation mode communication quality requirement determination unit 232 compares the required quality corresponding to the current speed with the predicted value, and determines whether the current communication quality is sufficient for executing the current operation mode.

If the measured value is not a value that meets the required quality, the operation mode communication quality requirement determination unit 232 generates operation data instructing deceleration as necessary, and supplies that operation data to the automated/remote driving control unit 220.

Note that after instructing the deceleration, the operation mode communication quality requirement determination unit 232 may notify the controller 300 that the deceleration has been performed, and the controller 300 may notify the remote operator by displaying the content of the notification.

Before instructing the deceleration, the operation mode communication quality requirement determination unit 232 can also send an approval request to the controller 300, and instruct the deceleration when the remote operator performs an operation for approval.

### Example of Configuration of Operation Mode Communication Quality Requirement Determination Unit

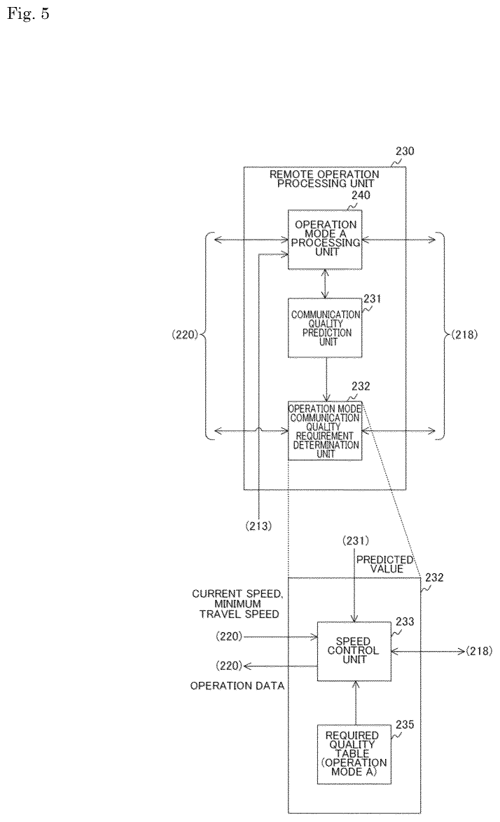

FIG. 5 is a block diagram illustrating an example of the configuration of the operation mode communication quality requirement determination unit 232 in the first embodiment of the present technique. The operation mode communication quality requirement determination unit 232 includes a speed control unit 233 and a required quality table 235.

The required quality table 235 is a table in which a required quality is associated with each of speeds in the operation mode A. Although the required quality table 235 is held in the mobile device 200, the configuration is not limited thereto. For example, a configuration is also possible in which the mobile device 200 stores the required quality table 235 on a node outside of the mobile device 200, and the mobile device 200 accesses and references the table over the Internet or the like.

The speed control unit 233 controls the travel speed of the mobile device 200 according to whether the predicted value of the communication quality meets the required quality corresponding to the current speed. The speed control unit 233 reads out the required quality corresponding to the current speed from the required quality table 235, and compares the required quality with the predicted value. If the predicted value does not meet the required quality, the speed control unit 233 refers to the required quality table 235 to determine whether there is a speed that is not less than the minimum travel speed and that meets the required quality. If there is such a suitable speed, the speed control unit 233 causes the mobile device 200 to decelerate to that speed.

On the other hand, if there is no such suitable speed, the speed control unit 233 determines that remote operation cannot be performed, and causes the driving mode to switch to a non-remote driving mode (such as the non-remote automated driving mode or the non-remote manual driving mode). This control of the speed is repeatedly performed, at a constant period, for example. Alternatively, the speed is controlled when a predetermined event occurs, such as when the communication quality changes.

As described above, the speed control unit 233 controls the travel speed on the basis of the predicted value of the communication quality, and thus when the communication quality decreases, the speed is reduced to an appropriate speed to make the operations by the remote operator easier,

This makes it possible to reduce the risk of the operator overlooking obstacles, humans, and the like. Through this, the safety of the mobile device 200 can be improved.

### Example of Configuration of Controller

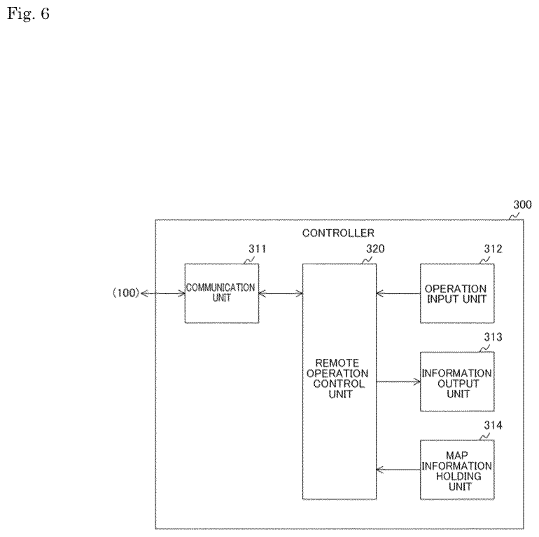

FIG. 6 is a block diagram illustrating an example of the configuration of the controller 300 in the first embodiment of the present technique. The controller 300 includes a communication unit 311, an operation input unit 312, an information output unit 313, a map information holding unit 314, and a remote operation control unit 320.

The communication unit 311 communicates with the mobile device 200 through the macro cell 110, the communication network 100, and the like.

The operation input unit 312 generates operation data in accordance with operations made by the remote operator through an input device. A steering wheel, an accelerator, a brake pedal, and the like can be given as specific examples of input devices. The operation input unit 312 supplies the operation data to the remote operation control unit 320.

The information output unit 313 outputs video of the surroundings, statuses, notification messages (notifications of anomalies in the mobile device 200, notifications from the automated driving system, and the like), and the like of the mobile device 200 as video, audio, and the like, and presents these to the remote operator.

The map information holding unit 314 holds map information used for a navigation function.

The remote operation control unit 320 generates data for the information output unit 313 on the basis of the data from the communication unit 311 and the map information holding unit 314, and generates data for the communication unit 311 on the basis of the data from the operation input unit 312.

### Example of Configuration of Remote Operation Control Unit

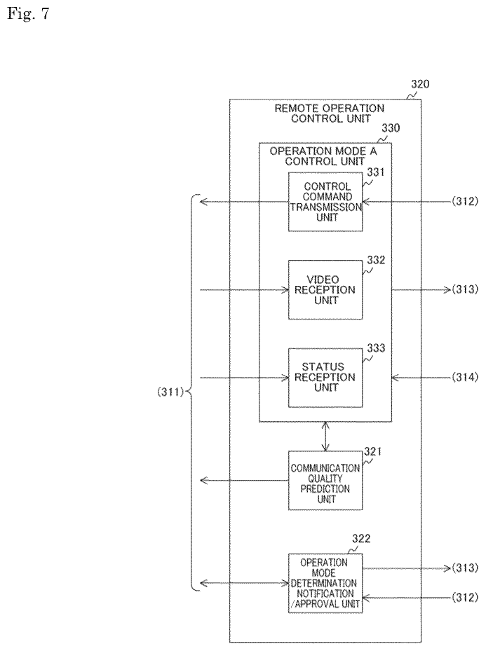

FIG. 7 is a block diagram illustrating an example of the configuration of the remote operation control unit 320 in the first embodiment of the present technique. The remote operation control unit 320 includes an operation mode A control unit 330, a communication quality prediction unit 321, and an operation mode determination notification/approval unit 322.

The operation mode A control unit 330 includes a control command transmission unit 331, a video reception unit 332, and a status reception unit 333.

The control command transmission unit 331 generates control commands for controlling the mobile device 200 on the basis of the operation data from the operation input unit 312, and transmits the control commands to the mobile device 200 through the communication unit 311.

The video reception unit 332 receives and decodes the video data from the mobile device 200 using a real-time data communication protocol such as RTP, and supplies the resulting video to the information output unit 313. The status reception unit 333 receives the status from the mobile device 200.

The operation mode A control unit 330 generates display data, audio data, and the like on the basis of the video of the surroundings, statuses, map information, and the like, and supplies the display data and audio data to the information output unit 313.

The communication quality prediction unit 321 predicts the communication quality of the communication path from the mobile device 200 to the controller 300 (i.e., the uplink). The standard deviation of average throughput, the average latency, and the jitter within a set period of time is measured and calculated as the communication quality, for example. A delay measurement packet is transmitted from the communication quality prediction unit 321 to the mobile device 200. The communication quality prediction unit 321 transmits the predicted value of the communication quality to the mobile device 200.

The operation mode determination notification/approval unit 322 supplies data of which the remote operator is to be notified to the information output unit 313, and returns a response to the notification to the mobile device 200 on the basis of the content of operations made in the operation input unit 312.

For example, when the operation mode communication quality requirement determination unit 232 on the mobile device 200 side makes a notification for deceleration, the operation mode determination notification/approval unit 322 generates display data to that effect and supplies the display data to the information output unit 313.

When the operation mode communication quality requirement determination unit 232 has transmitted an approval request prior to instructing deceleration, the operation mode determination notification/approval unit 322 generates display data for receiving approval and supplies that display data to the information output unit 313. Then, when operation data for approval or rejection is input from the operation input unit 312, the operation mode determination notification/approval unit 322 returns a response indicating approval or rejection to the mobile device 200 through the communication unit 311.

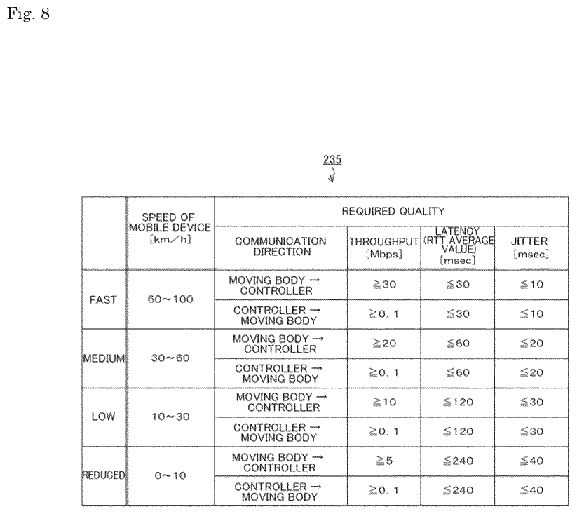

FIG. 8 is a diagram illustrating an example of the required quality for each of speeds of the mobile device 200 in the first embodiment of the present technique. Speed ranges of the mobile device 200 are categorized as “fast”, “medium”, “low”, “reduced”, and the like. The required communication quality (required quality) for each category is written in the required quality table 235. A higher required quality is set as the speed increases.

Here, “X to Y” in the figure refers to a range of at least “X” kilometers per hour (km/h) or higher to “Y” kilometers per hour (km/h) or lower.

The required quality is expressed, for example, by at least one of throughput, latency, and jitter for each communication direction. The communication direction is one of the direction from the mobile device 200 to the controller 300 (downlink) and the direction from the controller 300 to the mobile device 200 (uplink).

For example, in the direction from the mobile device 200 to the controller 300 (downlink) at “fast” speed, a throughput of 30 megabits per second or higher, a latency of 30 milliseconds or lower, and jitter of 10 milliseconds or lower are required.

As described above, if the predicted value of the communication quality does not meet the required quality corresponding to the current speed, the speed control unit 233 controls the travel speed to a speed that is at least the minimum travel speed and that meets the required quality. For example, assume that the current speed is 70 kilometers per hour (km/h), and the predicted value does not meet the corresponding required quality. Assume also that the minimum travel speed is 30 kilometers per hour (km/h). Furthermore, assume that the required quality corresponding to a medium speed of at least 30 kilometers per hour (km/h) but less than 60 kilometers per hour (km/h) meets the predicted value.

In this case, the speed control unit 233 causes the mobile device 200 to decelerate to a speed within the medium speed range. Although the required quality corresponding to “low” speed and “reduced” speed, which are less than 30 kilometers per hour (km/h), also meets the predicted values, these ranges are lower than the minimum travel speed. Therefore, unless there are circumstances such as avoiding an accident, the speed is not reduced to a speed within those ranges.

Although the mobile device 200 obtains the required quality corresponding to the current speed from the table illustrated in this figure, the configuration is not limited thereto. For example, the mobile device 200 can also obtain the required quality through a calculation using a predetermined function f(v) that returns the required quality when a current speed v is input.

### Example of Operations of Mobile Device

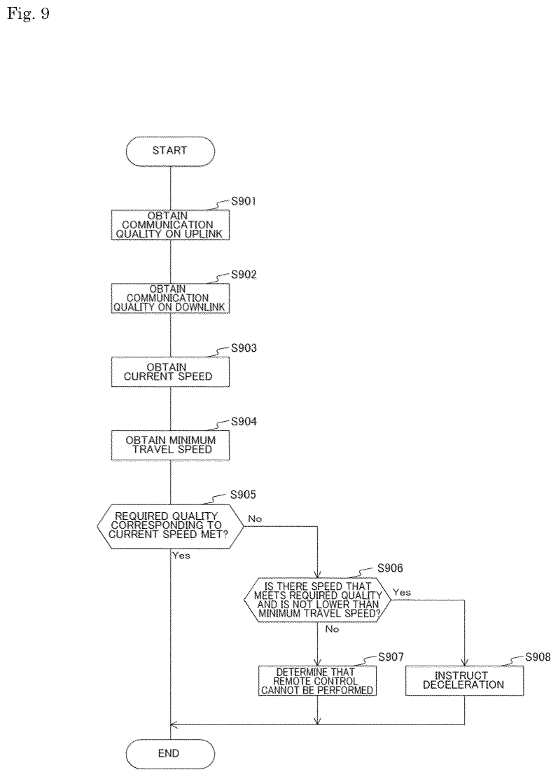

FIG. 9 is a flowchart illustrating an example of operations by the mobile device 200 in the first embodiment of the present technique. These operations are started, for example, when the remote driving mode is set.

The remote operation processing unit 230 in the mobile device 200 obtains the communication quality on the uplink (step S901), and obtains the communication quality on the downlink (step S902). The remote operation processing unit 230 also obtains the current speed of the mobile device 200 (step S903), and obtains the minimum travel speed (step S904).

The remote operation processing unit 230 then refers to the required quality table 235 and determines whether the communication quality corresponding to the current speed meets the required quality (step S905). If the communication quality corresponding to the current speed meets the required quality (step S905: Yes), the remote operation processing unit 230 ends the operations for controlling the travel speed.

On the other hand, if the communication quality corresponding to the current speed does not meet the required quality (step S905: No), the remote operation processing unit 230 determines whether there is a speed that meets the required quality and that is not lower than the minimum travel speed (step S906).

If there is no speed that meets the required quality and that is not lower than the minimum travel speed (step S906: No), the remote operation processing unit 230 determines that remote operations cannot be performed (step S907), switches to a non-remote driving mode, and ends the operations for controlling the travel speed.

On the other hand, if there is a speed that meets the required quality and that is not lower than the minimum travel speed (step S906: Yes), the remote operation processing unit 230 instructs deceleration to that speed (step S908), and ends the operations for controlling the travel speed.

The processing illustrated in the figure is executed, for example, at a set period, or when a predetermined event occurs.

In this manner, according to the first embodiment of the present technique, the speed control unit 233 controls the travel speed on the basis of the predicted value of the communication quality, and thus when the communication quality decreases, the speed can be reduced to an appropriate speed to improve the safety of the mobile device 200.

### 2. Second Embodiment

In the first embodiment described above, the speed control unit 233 determines whether there is a speed that meets the required quality and is not lower than the minimum travel speed, and decelerates if there is such an appropriate speed. In this configuration, if there is no appropriate speed, the remote driving mode cannot be continued. The mobile device 200 in this second embodiment differs from the first embodiment in that one of the plurality of operation modes is selected on the basis of the predicted value of the communication quality.

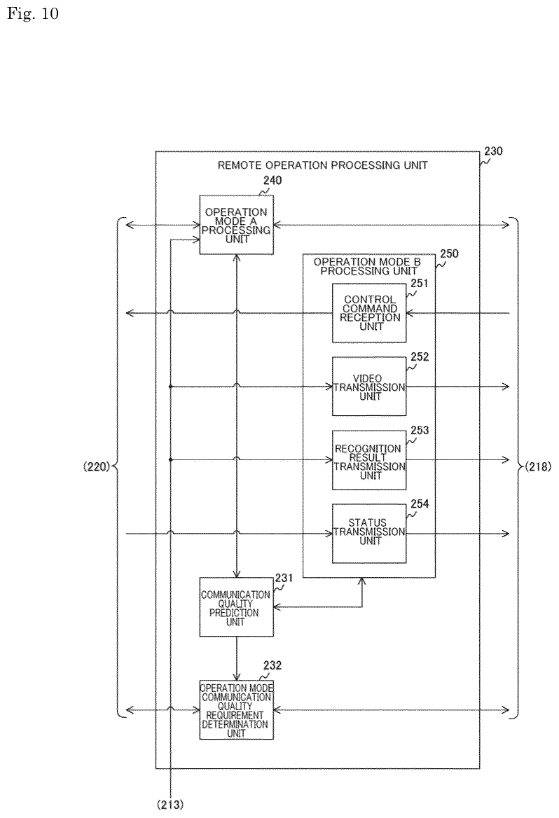

FIG. 10 is a block diagram illustrating an example of the configuration of the remote operation processing unit 230 in the second embodiment of the present technique. A plurality of operation modes are provided for remote driving modes in the second embodiment, and the remote operation processing unit 230 can select and set any one thereof. For example, it is assumed that either an operation mode A or an operation mode B is set.

The operation mode B is an operation method in which the mobile device 200 is remotely operated using task-level commands for executing actions that have a set meaning with a higher degree of abstraction than lower-level operation methods (operating the steering wheel, accelerator, the brakes, and the like).

In the operation mode B, the remote operator determines the state in the periphery of the mobile device 200 based on map information of the periphery of the mobile device 200, video information from a camera mounted on the mobile device 200, and/or peripheral recognition information from a sensor mounted on the mobile device 200. After determining the state in the periphery, the remote operator inputs, to the controller 300, a task-level command to execute an action having a set meaning. Depending on the command, it is necessary to add parameters. The mobile device 200 interprets the commands received from the controller 300, and taking into account the map information, the peripheral recognition information, and the like held in the mobile device 200, converts the commands into control instructions for the steering wheel, accelerator, brakes, and the like to determine the actions of the mobile device 200 and control the mechanisms thereof.

The commands used in the operation mode B include “straight travel in same lane”, “lane change left (or right)”, “decelerate/accelerate”, “stop”, and the like. Other examples include “turn left (or right) at designated angle”, “park in designated parking space”, “make U-turn at designated location”, “move to designated location”, “stop on left (or right) shoulder”, and the like. The specific details of the “angle”, “parking lot”, and “location” of these commands are specified by parameters.

Additionally, the operation mode B does not assume that the commands entered by the controller 300 are executed immediately and with low latency. It is assumed that in this operation mode, both the execution of the instructed task-level control commands and highly-urgent danger avoidance processing are determined and executed on the mobile device 200 side. For example, the mobile device 200 may perform vehicle control by detecting obstacles, surrounding vehicles, people, and the like, determining the likelihood of an accident occurring, and if the likelihood is high, determining an action plan for avoiding the danger (stopping, avoidance, and the like).

Although the operation mode B provides less freedom of operation than with the intuitive operations performed in the operation mode A, in the operation mode B, the vehicle can be operated even when the communication quality between the mobile device 200 and the controller 300 is low.

The remote operation processing unit 230 of the second embodiment differs from the first embodiment in that an operation mode B processing unit 250 is further provided. The operation mode B processing unit 250 includes a control command reception unit 251, a video transmission unit 252, a recognition result transmission unit 253, and a status transmission unit 254.

The control command reception unit 251 receives the task-level control commands from the controller 300 in the operation mode B and supplies the control commands to the automated/remote driving control unit 220.

The video transmission unit 252 receives the video data from the camera 213 in the operation mode B, encodes the video data, and transmits the video data to the controller 300 through the communication unit 218. The video transmission unit 252 also controls the transmission rate of the video data in accordance with the reception quality status of the video data from the controller 300.

The recognition result transmission unit 253 receives recognition data on the state in the periphery of the mobile device 200 from the camera 213 in the operation mode B, and transmits the recognition data to the controller 300 through the communication unit 218. This recognition data is superimposed on the map information and displayed on the controller 300 side, for example.

The status transmission unit 254 receives the status of the mobile device 200 from the automated/remote driving control unit 220 in the operation mode B, and transmits the status to the controller 300 through the communication unit 218.

The communication quality prediction unit 231 of the second embodiment monitors the selected one of the operation mode A processing unit 240 and the operation mode B processing unit 250 to predict the communication quality, and supplies the obtained predicted value to the operation mode communication quality requirement determination unit 232.

Note that after instructing the operation mode to be switched, the operation mode communication quality requirement determination unit 232 may notify the controller 300 to that effect, and the controller 300 may notify the remote operator by displaying the content of the notification.

Before instructing the operation mode to be switched, the operation mode communication quality requirement determination unit 232 can also send an approval request to the controller 300, and instruct the switch when the remote operator performs an operation for approval.

Although the remote operation processing unit 230 is described as selecting either the operation mode A or the operation mode B, three or more operation modes can also be provided, with the remote operation processing unit 230 selecting any one thereof.

Furthermore, with the operation input unit 312 in the controller 200 of the second embodiment, the operation method is changed according to the selected operation mode. If the operation mode A is selected, the steering wheel, the accelerator, and the brakes are operated as described above. On the other hand, if the operation mode B is selected, an operation for selecting a command as described above is performed.

The information output unit 313 in the controller 200 of the second embodiment outputs the video of the surroundings, the status, notification messages, and the like as video or audio as described above when the operation mode A is selected. If the operation mode B is selected, options for commands to be made to the mobile device 200 are displayed.

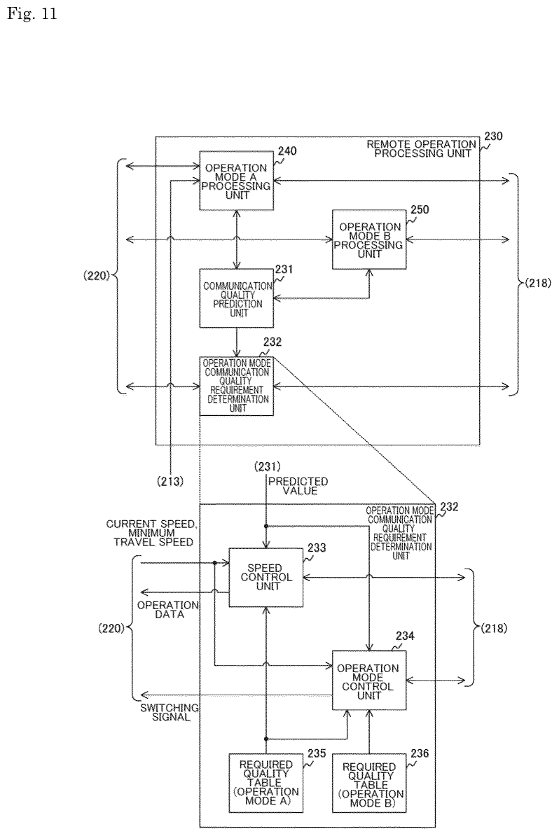

FIG. 11 is a block diagram illustrating an example of the configuration of the operation mode communication quality requirement determination unit 232 in the second embodiment of the present technique. The operation mode communication quality requirement determination unit 232 of the second embodiment differs from the first embodiment in that an operation mode control unit 234 and a required quality table 236 are further included.

The required quality table 236 holds required qualities corresponding to the operation mode B. The operation mode control unit 234 selects the operation mode on the basis of the predicted value of the communication quality. The operation mode control unit 234 selects, from the plurality of operation modes, an operation mode in which the predicted value can meet the required quality. Then, if the selected operation mode is not the current operation mode, the operation mode control unit 234 supplies a switching signal instructing a switch to the selected operation mode to the automated/remote driving control unit 220 to execute the switch. Although the required quality table 236 is held in the mobile device 200, the configuration is not limited thereto. For example, a configuration is also possible in which the mobile device 200 stores the required quality table 236 on a node outside of the mobile device 200, and the mobile device 200 accesses and references the table over the Internet or the like.

In this manner, the operation mode control unit 234 can switch to an appropriate mode according to the communication quality by selecting an operation mode on the basis of the predicted value of the communication quality. Through this, the safety of the mobile device 200 can be further improved.

When the operation mode A is selected, the speed control unit 233 controls the travel speed on the basis of the communication quality, as in the first embodiment.

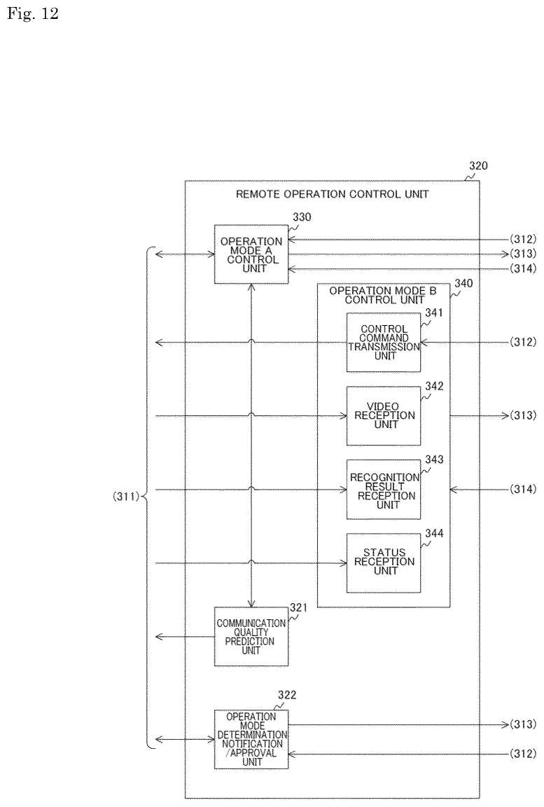

FIG. 12 is a block diagram illustrating an example of the configuration of the remote operation control unit 320 in the second embodiment of the present technique. The remote operation control unit 320 of the second embodiment differs from the first embodiment in that an operation mode B control unit 340 is further provided. The operation mode B control unit 340 includes a control command transmission unit 341, a video reception unit 342, a recognition result reception unit 343, and a status reception unit 344.

The control command transmission unit 341 generates task-level control commands along with parameters on the basis of operation data from the operation input unit 312 in the operation mode B, and transmits the control commands to the mobile device 200 through the communication unit 311.

The video reception unit 342 receives and decodes the video data from the mobile device 200 using a real-time data communication protocol such as RTP in the operation mode B, and supplies the resulting video to the information output unit 313.

The recognition result reception unit 343 receives the recognition data from the mobile device 200 in the operation mode B. The recognition result reception unit 343 superimposes the recognition data on the map information and causes the information output unit 313 to display the result.

The status reception unit 344 receives the status from the mobile device 200 in the operation mode B.

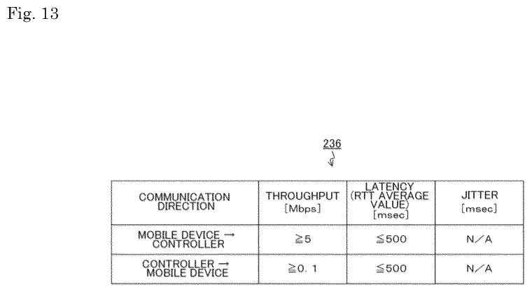

FIG. 13 is a diagram illustrating an example of a required quality corresponding to the operation mode B in the second embodiment of the present technique. As illustrated in the figure, the required quality table 236 holds the required quality (throughput, latency, jitter, and the like) for both the downlink and the uplink. Unlike the operation mode A, where the required quality changes according to the speed, a constant communication quality is required in the operation mode B, regardless of the speed.

Although the required quality is set independent of the speed in the operation mode B, the configuration is not limited thereto, and a required quality according to the speed can be set in the required quality table 236.

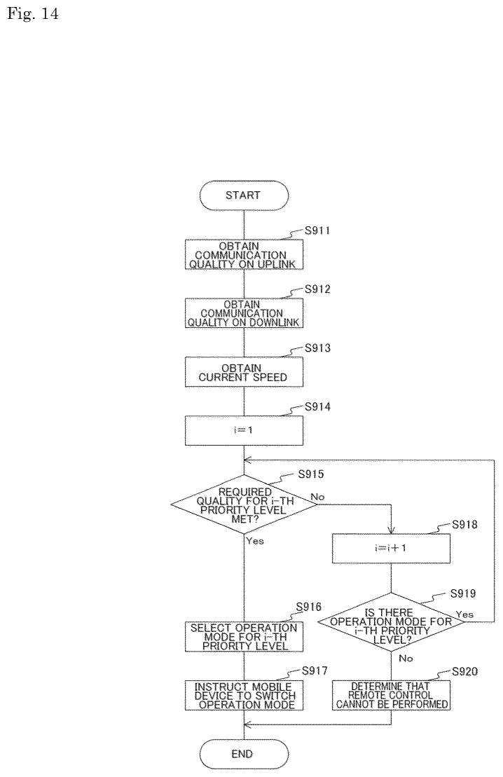

FIG. 14 is a flowchart illustrating an example of operations by the mobile device 200 in the second embodiment of the present technique. The remote operation processing unit 230 in the mobile device 200 obtains the communication quality on the uplink (step S911), and obtains the communication quality on the downlink (step S912). The remote operation processing unit 230 also obtains the current speed of the mobile device 200 (step S913), and resets a variable i to “1” (step S914). Here, it is assumed that a priority level is set in advance for each of the plurality of operation modes, such as the operation mode A and the operation mode B.

The remote operation processing unit 230 obtains, from the required quality table 235, the required quality table 236, or the like, the required quality corresponding to the mode, among the plurality of operation modes, having an i-th priority level. The remote operation processing unit 230 then determines whether the predicted value meets the required quality for the i-th priority level (step S915). Here, if the i-th operation mode is the operation mode A, the required quality corresponding to the current speed is read out from the required quality table 235.

If the predicted value meets the required quality for the i-th priority level (step S915: Yes), the remote operation processing unit 230 selects the i-th operation mode (step S916) and instructs a switch if necessary (step S917). After step S917, the remote operation processing unit 230 ends the operations for selecting the operation mode.

On the other hand, if the predicted value does not meet the required quality for the i-th priority level (step S915: No), the remote operation processing unit 230 increments i (step S918), and then determines whether there is an operation mode having the i-th priority level (step S919).

If there is an operation mode having the i-th priority level (step S919: Yes), the remote operation processing unit 230 repeats the processing of step S915 and on. On the other hand, if there is no operation mode having the i-th priority level (step S919: No), the remote operation processing unit 230 determines that remote operation cannot be performed (step S920), switches to the non-remote driving mode, and ends the operations for selecting the operation mode.

The processing for selecting the operation mode illustrated in the figure is executed, for example, at a set period, or when a predetermined event occurs. The control illustrated in this figure and the control of the speed illustrated in FIG. 9 are executed in parallel. When the operation mode A is selected by the operation mode control unit 234 from among the plurality of operation modes in FIG. 14, the speed control unit 233 controls the travel speed on the basis of the predicted value, as illustrated in FIG. 9.

Note that a configuration is also possible in which the mobile device 200 can only select the operation mode, without controlling the travel speed.

In this manner, according to the second embodiment of the present technique, the operation mode control unit 234 selects the operation mode on the basis of the predicted value for the communication quality, which makes it possible to further improve the safety of the mobile device 200.

### 3. Example of Application in Vehicle Control System

The technique according to the present disclosure (the present technique) can be applied in various products. For example, the technique according to the present disclosure may be realized as a device mounted on any type of moving body, such as an automobile, an electric automobile, a hybrid electric automobile, a motorcycle, a bicycle, a personal mobility device, an airplane, a drone, a ship, a robot, or the like.

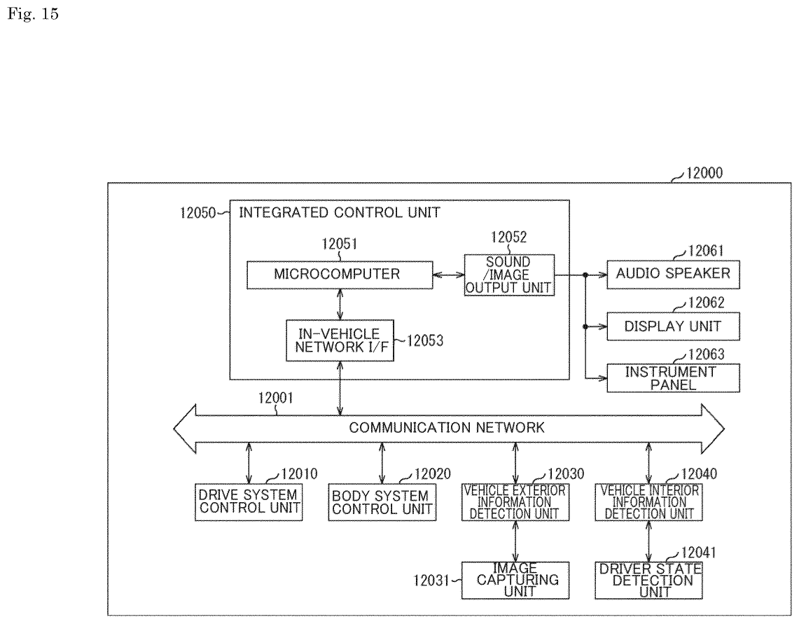

FIG. 15 is a block diagram schematically illustrating an example of the configuration of a vehicle control system, which is an example of a moving body control system to which the technique according to the present disclosure can be applied.

A vehicle control system 12000 includes a plurality of electronic control units connected over a communication network 12001. In the example illustrated in FIG. 15, the vehicle control system 12000 includes a drive system control unit 12010, a body system control unit 12020, a vehicle exterior information detection unit 12030, a vehicle interior information detection unit 12040, and an integrated control unit 12050. Additionally, a microcomputer 12051, a sound/image output unit 12052, and an in-vehicle network interface (I/F) 12053 are illustrated as functional configurations of the integrated control unit 12050.

The drive system control unit 12010 controls operations of devices related to a drive system of the vehicle according to various types of programs. For example, the drive system control unit 12010 functions as control devices, such as a driving force generation device for generating driving force for the vehicle, such as an internal combustion engine or a driving motor; a driving force transmission mechanism for transmitting driving force to wheels; a steering mechanism for adjusting a turning angle of the vehicle; a braking device that generates braking force for the vehicle; and the like.

The body system control unit 12020 controls operations of various devices mounted in the vehicle body according to various programs. For example, the body system control unit 12020 functions as control devices for a keyless entry system, a smart key system, power window devices, or various lamps such as headlights, backup lights, brake lights, turn signals, fog lights, and the like. In this case, radio waves emitted from a portable device that substitutes for a key or signals from various switches can be input to the body system control unit 12020. The body system control unit 12020 receives the input of the radio waves or signals and controls door lock devices, power window devices, the lamps, and the like of the vehicle.

The vehicle exterior information detection unit 12030 detects information on the exterior of the vehicle in which the vehicle control system 12000 is installed. For example, an image capturing unit 12031 is connected to the vehicle exterior information detection unit 12030. The vehicle exterior information detection unit 12030 causes the image capturing unit 12031 to capture an image of the exterior of the vehicle, and receives the captured image. The vehicle exterior information detection unit 12030 may perform object detection processing or distance detection processing for people, cars, obstacles, traffic signs, letters on the road, and the like on the basis of the received image.

The image capturing unit 12031 is an optical sensor that receives light and outputs an electrical signal according to the intensity of the received light. The image capturing unit 12031 can also output the electrical signal as an image or as distance measurement information. Additionally, the light received by the image capturing unit 12031 may be visible light or non-visible light such as infrared light.

The vehicle interior information detection unit 12040 detects information on the interior of the vehicle. For example, a driver state detection unit 12041 that detects a state of a driver is connected to the vehicle interior information detection unit 12040. The driver state detection unit 12041 includes, for example, a camera that captures an image of the driver, and the vehicle interior information detection unit 12040 may calculate the level of the driver's fatigue or concentration, or may determine whether the driver is dozing, on the basis of detection information input from the driver state detection unit 12041.

For example, the microcomputer 12051 can calculate control target values for the driving force generation device, the steering mechanism, or the braking device on the basis of information on the inside and outside of the vehicle obtained by the vehicle exterior information detection unit 12030 and the vehicle interior information detection unit 12040, and output control commands to the drive system control unit 12010. For example, the microcomputer 12051 can perform coordinated control for the purpose of implementing functions of an Advanced Driver Assistance System (ADAS) including vehicle collision avoidance, impact mitigation, following traveling based on an inter-vehicle distance, cruise control, vehicle collision warnings, and lane departure warnings.

Additionally, the microcomputer 12051 can perform coordinated control for the purpose of automated driving or the like in which autonomous travel is performed without requiring operations of the driver, by controlling the driving force generation device, the steering mechanism, the braking device, or the like on the basis of information about the surroundings of the vehicle, the information being obtained by the vehicle exterior information detection unit 12030 or the vehicle interior information detection unit 12040.

Additionally, the microcomputer 12051 can output control commands to the body system control unit 12020 on the basis of the information on the exterior of the vehicle obtained by the vehicle exterior information detection unit 12030. For example, the microcomputer 12051 can perform coordinated control for the purpose of suppressing glare, such as switching from high beams to low beams by controlling the headlights according to the position of a preceding vehicle or an oncoming vehicle detected by the vehicle exterior information detection unit 12030.

The sound/image output unit 12052 transmits an output signal of at least one of sound and an image to an output device capable of visually or audibly providing information to an occupant or to the exterior of the vehicle. In the example illustrated in FIG. 15, an audio speaker 12061, a display unit 12062, and an instrument panel 12063 are illustrated as examples of the output device. The display unit 12062 may include at least one of an on-board display and a heads-up display, for example.

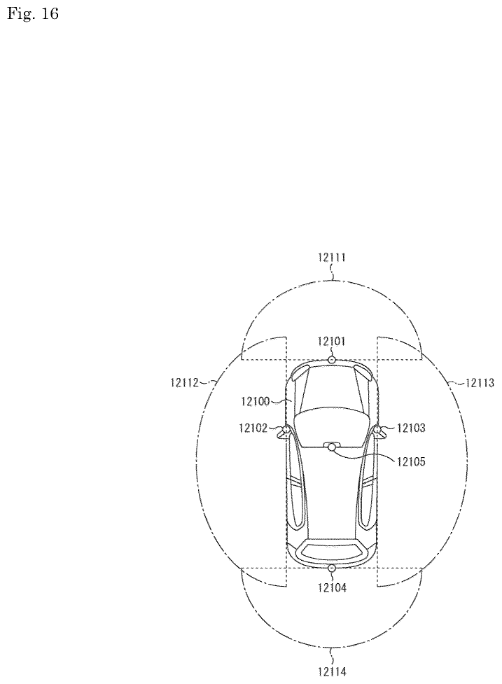

FIG. 16 is a diagram illustrating an example of an installation position of the image capturing unit 12031.

In FIG. 16, image capturing units 12101, 12102, 12103, 12104, and 12105 are provided as the image capturing unit 12031.

The image capturing units 12101, 12102, 12103, 12104, and 12105 are provided at the positions of the front nose, the side-view mirrors, the rear bumper, the trunk door, an upper part of the windshield within the vehicle cabin, and the like of a vehicle 12100, for example. The image capturing unit 12101 provided on the front nose and the image capturing unit 12105 provided in an upper part of the windshield within the vehicle cabin mainly obtain images from in front of the vehicle 12100. The image capturing units 12102 and 12103 provided in the side- view mirrors mainly obtain images from the sides of the vehicle 12100. The image capturing unit 12104 provided on the rear bumper or the trunk door mainly obtains images of an area behind the vehicle 12100. The image capturing unit 12105 provided on an upper part of the windshield within the vehicle cabin is mainly used for detecting preceding vehicles, pedestrians, obstacles, traffic signals, traffic signs, lanes, and the like.

FIG. 16 illustrates an example of image capturing ranges of the image capturing units 12101 to 12104. An image capturing range 12111 indicates an image capturing range of the image capturing unit 12101 provided on the front nose; image capturing ranges 12112 and 12113 respectively indicate the image capturing ranges of the image capturing units 12102 and 12103 provided in the side-view mirrors; and an image capturing range 12114 indicates the image capturing range of the image capturing unit 12104 provided on the rear bumper or the trunk door. For example, by superimposing image data captured by the image capturing units 12101 to 12104, it is possible to obtain a bird's-eye view image seen from above the vehicle 12100.

At least one of the image capturing units 12101 to 12104 may have a function for obtaining distance information. For example, at least one of the image capturing units 12101 to 12104 may be a stereo camera constituted by a plurality of image sensors, or may be an image sensor that has pixels for phase difference detection.

For example, the microcomputer 12051 can extract, particularly, a closest three- dimensional object on a path through which the vehicle 12100 is traveling, which is a three-dimensional object traveling at a predetermined speed (e.g., 0 km/h or higher) in substantially the same direction as the vehicle 12100, as a preceding vehicle by obtaining a distance to each three-dimensional object in the image capturing ranges 12111 to 12114 and a temporal change in the distance (a relative speed with respect to the vehicle 12100) based on distance information obtained from the image capturing units 12101 to 12104. The microcomputer 12051 can also set a following distance to the preceding vehicle to be maintained in advance and perform automatic brake control (including following stop control) and automatic acceleration control (including following start control). It is therefore possible to perform coordinated control for the purpose of, for example, automated driving in which the vehicle travels in an automated manner without requiring the driver to perform operations.

For example, the microcomputer 12051 can classify and extract three-dimensional data regarding three-dimensional objects as two-wheeled vehicles, normal vehicles, large vehicles, pedestrians, and other three-dimensional objects such as electrical poles based on the distance information obtained from the image capturing units 12101 to 12104, and can use the three-dimensional data to automatically avoid obstacles. For example, the microcomputer 12051 classifies obstacles around the vehicle 12100 into obstacles visible to the driver of the vehicle 12100 and obstacles which are difficult to see. Then, the microcomputer 12051 determines a collision risk indicating the degree of risk of collision with each obstacle, and when the collision risk is at least a set value and there is a possibility of a collision, an alarm is output to the driver through the audio speaker 12061 or the display unit 12062, forced deceleration or avoidance steering is performed through the drive system control unit 12010, and the like, making it possible to provide driving assistance for collision avoidance.

At least one of the image capturing units 12101 to 12104 may be an infrared camera that detects infrared rays. For example, the microcomputer 12051 can recognize a pedestrian by determining whether there is a pedestrian in an image captured by the image capturing units 12101 to 12104. Such pedestrian recognition is performed by, for example, a sequence in which feature points in the images captured by the image capturing units 12101 to 12104 as infrared cameras are extracted and a sequence in which pattern matching processing is performed on a series of feature points indicating an outline of an object to determine whether the object is a pedestrian. When the microcomputer 12051 determines that there is a pedestrian in the image captured by the image capturing units 12101 to 12104 and the pedestrian is recognized, the sound/image output unit 12052 controls the display unit 12062 such that a square contour line for emphasis is superimposed on and displayed with the recognized pedestrian. Additionally, the sound/image output unit 12052 may control the display unit 12062 such that an icon indicating a pedestrian or the like is displayed at a desired position.

An example of the vehicle control system to which the technique according to the present disclosure can be applied has been described thus far. The technique according to the present disclosure may be applied to the vehicle control system 12000 and the like among the above-described configurations. Specifically, the system of the mobile device 200 illustrated in FIG. 1 can be applied to the vehicle control system 12000. Applying the technique according to the present disclosure to the vehicle control system 12000 makes it possible to further improve the safety of the system.

Note that the embodiments described above are examples of embodiments of the present technique, and the matters in the embodiments correspond to the matters specifying the invention set forth in the scope of patent claims. Likewise, the matters specifying the invention set forth in the scope of patent claims correspond to the matters in the embodiments of the present technique which have the same names. However, the present technique is not limited to the embodiments, and can be embodied by making various modifications to the embodiments within a scope that does not depart from the essential spirit thereof.

Additionally, the processing sequences in the above-described embodiments may be understood as methods including a series of procedures or may be understood as a program that causes a computer to perform a series of procedures and a recording medium that stores the program. As the recording medium, for example, a Compact Disc (CD), a MiniDisc (MD), a Digital Versatile Disc (DVD), a memory card, a Blu-ray (registered trademark) Disc, or the like can be used.

Note that the effects described in the present specification are merely exemplary and not intended to be limiting, and other effects may be provided as well.

Note that the present technique can also have the following configurations.
(1) A mobile device including:
a communication unit that transmits and receives data to and from a controller through a predetermined communication path;
a communication quality prediction unit that predicts a communication quality of the communication path and obtains a predicted value;
an operation mode control unit that, on the basis of the predicted value, selects one of a plurality of operation modes, each defining an operation method for a remote operator of the controller; and
a speed control unit that controls a travel speed on the basis of the predicted value when a specific operation mode is selected from among the plurality of operation modes.
(2) The mobile device according to (1),

wherein when the predicted value does not meet a required quality that is a communication quality required for a current speed, the speed control unit controls the travel speed to a speed that is not lower than a predetermined minimum travel speed and that meets the required quality.
(3) The mobile device according to (2), further including:
a required quality table in which a required quality is associated with each of speeds,
wherein the speed control unit obtains the required quality from the required quality table.
(4) The mobile device according to any one of (1) to (3), wherein
a required quality that is a required communication quality is associated with each of the plurality of operation modes, and
the operation mode control unit selects, from the plurality of operation modes, an operation mode in which the predicted value meets the required quality.
(5) The mobile device according to any one of (1) to (4),
wherein the communication path includes an uplink that is a path from the controller to the mobile device, and a downlink that is a path from the mobile device to the controller.
(6) The mobile device according to any one of (1) to (5),
wherein the communication quality includes at least one of an average throughput, an average latency, and jitter.
(7) A method for controlling a mobile device, the method including:
transmitting and receiving data to and from a controller through a predetermined communication path;
predicting a communication quality of the communication path and obtaining a predicted value;
selecting, on the basis of the predicted value, one of a plurality of operation modes, each defining an operation method for a remote operator of the controller; and
controlling a travel speed on the basis of the predicted value when a specific operation mode is selected from among the plurality of operation modes.

### Reference Signs List

100 Communication network
110 Macro cell
111, 112 Small cell
151-153 Base station
200 Mobile device
211 Radar
212 LiDAR
213 Camera
214, 312 Operation input unit
215 GPS module
216 Mechanism control unit
217, 313 Information output unit
218, 311 Communication unit
220 Automated/remote driving control unit
221 Peripheral state recognition unit
222 Action determination unit
223 Movement status obtainment unit
230 Remote operation processing unit
231, 321 Communication quality prediction unit
232 Operation mode communication quality requirement determination unit
233 Speed control unit
234 Operation mode control unit
235, 236 Required quality table
240 Operation mode A processing unit
241, 251 Control command reception unit
242, 252 Video transmission unit
243, 254 Status transmission unit
250 Operation mode B processing unit
253 Recognition result transmission unit
300 Controller
314 Map information holding unit
320 Remote operation control unit
322 Operation mode determination notification/approval unit
330 Operation mode A control unit
331, 341 Control command transmission unit
332, 342 Video reception unit
333, 344 Status reception unit
340 Operation mode B control unit
343 Recognition result reception unit
400 Time server
12000 Vehicle control system

1. A mobile device comprising:
a communication unit that transmits and receives data to and from a controller through a predetermined communication path;
a communication quality prediction unit that predicts a communication quality of the communication path and obtains a predicted value;
an operation mode control unit that, on the basis of the predicted value, selects one of a plurality of operation modes, each defining an operation method for a remote operator of the controller; and
a speed control unit that controls a travel speed on the basis of the predicted value when a specific operation mode is selected from among the plurality of operation modes.

2. The mobile device according to claim 1,
wherein when the predicted value does not meet a required quality that is a communication quality required for a current speed, the speed control unit controls the travel speed to a speed that is not lower than a predetermined minimum travel speed and that meets the required quality.

3. The mobile device according to claim 2, further comprising:
a required quality table in which a required quality is associated with each of speeds,
wherein the speed control unit obtains the required quality from the required quality table.

4. The mobile device according to claim 1, wherein
a required quality that is a required communication quality is associated with each of the plurality of operation modes, and
the operation mode control unit selects, from the plurality of operation modes, an operation mode in which the predicted value meets the required quality.

5. The mobile device according to claim 1,
wherein the communication path includes an uplink that is a path from the controller to the mobile device, and a downlink that is a path from the mobile device to the controller.

6. The mobile device according to claim 1,
wherein the communication quality includes at least one of an average throughput, an average latency, and jitter.

7. A method for controlling a mobile device, the method comprising:
transmitting and receiving data to and from a controller through a predetermined communication path;
predicting a communication quality of the communication path and obtaining a predicted value;
selecting, on the basis of the predicted value, one of a plurality of operation modes, each defining an operation method for a remote operator of the controller; and
controlling a travel speed on the basis of the predicted value when a specific operation mode is selected from among the plurality of operation modes.
